(19) United States
(12) Patent Application Publication
(10) Pub. No.: US 2004/0258336 A1
(43) Pub. Date: Dec. 23, 2004

(54) Structure of rotary protector

(76) Inventor: Kai-Chung Hou, Taoyuan (TW)

Correspondence Address: Richard P. Berg, Esq., c/o LADAS & PARRY, Suite 2100, 5670 Wilshire Boulevard, Los Angeles, CA, 90036-5679, US

(21) Appl. No.: 10/871,457

(22) Filed: Jun. 18, 2004

(30) Foreign Application Priority Data
Jun. 19, 2003 (TW) 092116693

(51) Int. Cl. F16C 35/00; F16C 33/02

(52) U.S. Cl. 384/276

(57) ABSTRACT

This invention is a structure of a rotary protection cap used for stuffing into an opening of a connecter to protect the connecter and being able to be rotated around a rotary axle when being pulled out from the opening. The structure comprises the rotary protection cap and a housing. The rotary protection cap comprises a first base, a protrusion, a rotary axle, and a second base. The protrusion, located at the first end of a first surface of the first base, is used for stuffing into or pulling out from the opening. The rotary axle is located in a second end of the first surface and is used for making the rotary protection cap able to be rotated when the protrusion is pulled from the opening. The second base is opposite to the first base and connects the rotary axle with the second surface. The connecter attaches to the inner side of the housing, which comprises a fillister for placing the rotary axle, and makes the first base to be located at the outer side and the second base in the inner side to make the rotary axle rotate in the fillister.

### BACKGROUND OF THE INVENTION

1. Field of the Invention

The present invention relates to a structure of a rotary protection cap; particularly, the rotary protection cap structure is used for protecting a connecter by pushing into an opening of the connecter, and it is rotatable when a rotary protection cap is pulled out from the opening.

2. Description of the Prior Art

For a mobile phone, the application of an earphone is an essential function, not only for listening and speaking, but also for receiving music and broadcasts. However, without any protection from an earphone cap, an opening of a connecter of the earphone can be invaded easily by dust and humidity, causing damage to the connector; thus, an excellent earphone cap for the protection of the connector is essential and important.

There are two conventional methods used in earphone caps. One is the pressing method that fixes the position of an earphone cap by pressing together the upper and lower housing of the mobile phone; the other is the push-in method which is done by distorting the earphone cap, so it can be pushed into the upper or lower housing and be stabilized by the structures in the inner side of the housing. However, the earphone cap design using these two methods must allow it to be bent and deformed to let the earphone plug pushed into the earphone jack. Being bent and distorted over a long period of time, the external appearance and functions of the earphone cap may also be damaged. Hence, the present invention provides the structure of rotary protection cap to solve the problem mentioned above.

### SUMMARY OF THE INVENTION

The objective of the present invention is to provide a structure of a rotary protection cap that is pushed into an opening of a connecter to protect the connecter, and it is rotatable when being pulled out from the opening.

The structure of the present invention comprises the rotary protection cap and a housing. The rotary protection cap comprises a first base, a protrusion, a rotary axle, and a second base. The first base comprises a first surface, and the protrusion is located at the first end of the first surface for pushing into or pulling out of the opening. The rotary axle is located at the second end of the first surface for enabling the rotary protection cap to rotate when the protrusion is pulled out from the opening. The second base is opposite to the first base and connects the rotary axle with the second surface. The connecter attaches to an inner side of a housing. The housing comprises a fillister for placing the rotary protection cap; it makes the first base be located at the outer side and the second base in the inner side as well as enables the cap to rotate in the fillister.

The structure of the rotary protection cap of the present invention makes use of the rotary protection cap and the housing structure to operate in coordination, enabling the protection cap to rotate in a predetermined range, which is more convenient for the user to operate.

The advantage and spirit of the invention may be understood by the following recitations together with the appended drawings.

### BRIEF DESCRIPTION OF THE APPENDED DRAWINGS

FIG. 1 is a view of the structure of the rotary protection cap of the present invention.

FIG. 2 is a view of the housing of the structure of rotary protection cap of the present invention.

FIG. 3 is a top view of the structure of the rotary protection cap in the state of stuffing shown in FIG. 1 and FIG. 2.

FIG. 4 is a view of the second base and the stopper of the rotary protection cap shown in FIG. 3.

FIG. 5 is a top view of the structure of rotary protection cap in the state of stuffing shown of FIG. 1 and FIG. 2 in the state of being pulled out.

FIG. 6 is an outside view of the second base and the stopper of the rotary protection cap shown in FIG. 5.

### DETAILED DESCRIPTION OF THE INVENTION

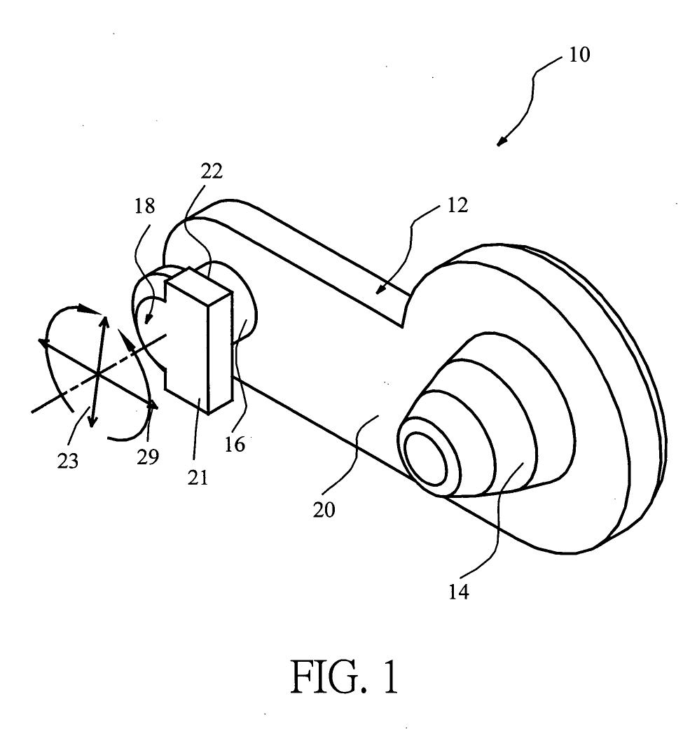

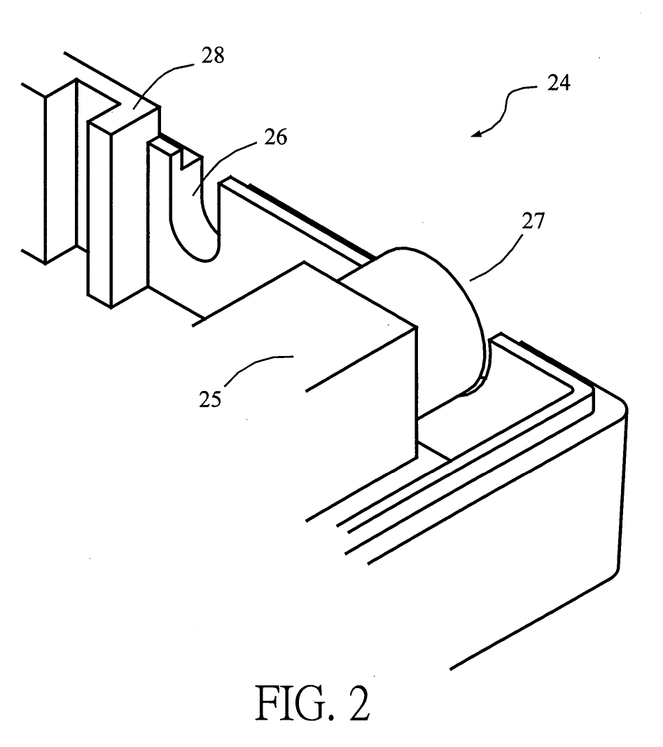

Please refer to FIG. 1 and FIG. 2. FIG. 1 is a view of the structure of the rotary protection cap 10 of the present invention. FIG. 2 is a view of the housing 24 of the structure of the rotary protection cap 10 of the present invention.

The present invention provides a rotary protection cap structure, which comprises the rotary protection cap 10 and the housing 24. The structure of the rotary protection cap 10 of the present invention is used for pushing into an opening 27 of the connecter 25 to prevent the connecter 25 from being invaded by dust and humidity via the opening 27, as well as to protect the connecter 25 and enables a rotary axle to rotate when pulling out from the opening 27. The connecter 25 attaches to the inner side of the housing 24.

As shown in FIG. 1, the rotary protection cap 10 comprises a first base 12, a protrusion 14, a rotary axle 16, and a second base 18. The first base 12 comprises a first surface 20. The protrusion 14 is located at the first end of the first surface 20 and is used for pushing into or pulling out of the opening 27. The rotary axle 16 is located at the second end of the first surface 20 and enables the rotary protection cap 10 being rotatable around the rotary axle 16 when the protrusion 14 is pulled out from the opening 27. The second base 18 is opposite to the first base 12 and connects the rotary axle 16 with a second surface 22. The rotary axle 16 is a specific multidimensional pillar for enabling the rotary protection cap 10 to be rotated and stabilized in a specific angle. The rotary protection cap 10 can be made of plastic, rubber or flexible material. The integral rotary protection cap 10 can be constructed to an one-piece-product via an injection molding manufacture process.

In addition, the second base 18 connects to the rotary protection cap 10 where it defines a first orientation 23 and a second orientation 29. The second base 18 extends a pillar 21 along the first orientation 23. As shown in FIG. 2, the connecter 25 attaches to the inner side of the housing 24. The housing 24 comprises a fillister 26 for placing the rotary axle 16, makes the first base 12 to be located at the outer side and the second base 18 in the inner side of the housing 24, as well as enables the rotary protection cap 10 being rotatable in the fillister 26. The housing 24 further comprises a stopper 28 in the inner side of the housing 24 to stop the rotary protection cap 10 when the second base 18 contacts to the stopper 28 when the rotary protection cap 10 is rotated.

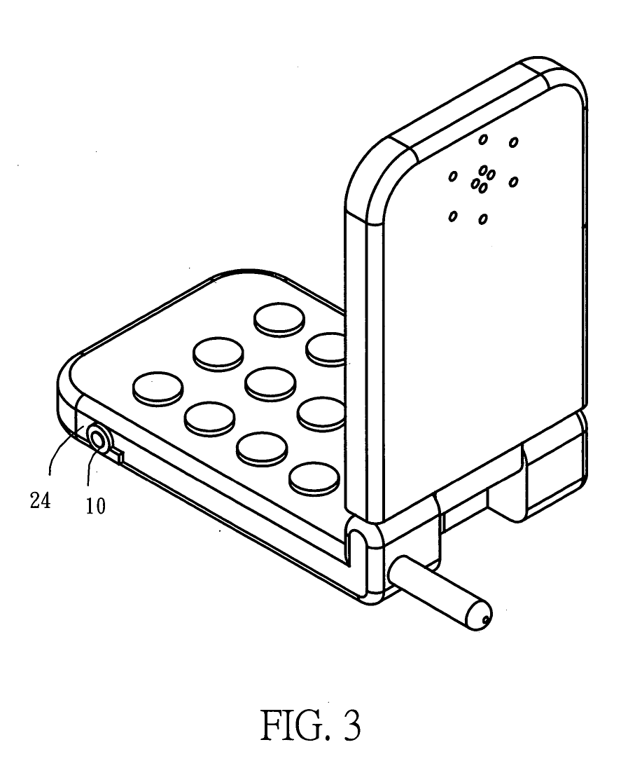

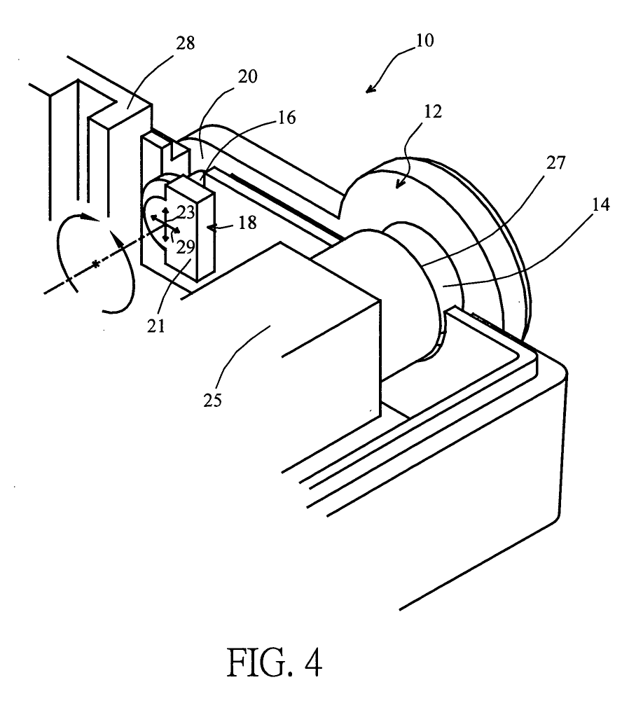

Please refer to FIG. 3 and FIG. 4. FIG. 3 is a top view of the structure of the rotary protection cap 10 in the state of stuffing shown in FIG. 1 and FIG. 2. FIG. 4 is a view of the second base 18 and the stopper 28 of the rotary protection cap 10 shown in FIG. 3.

When the protrusion 14 of the rotary protection cap 10 is pushed into the opening 27 of the connecter 25, the rotary protection cap 10 is fixed. There is no contact between the pillared shape 21 of the second base 18 and the stopper 28 located in the second orientation 29.

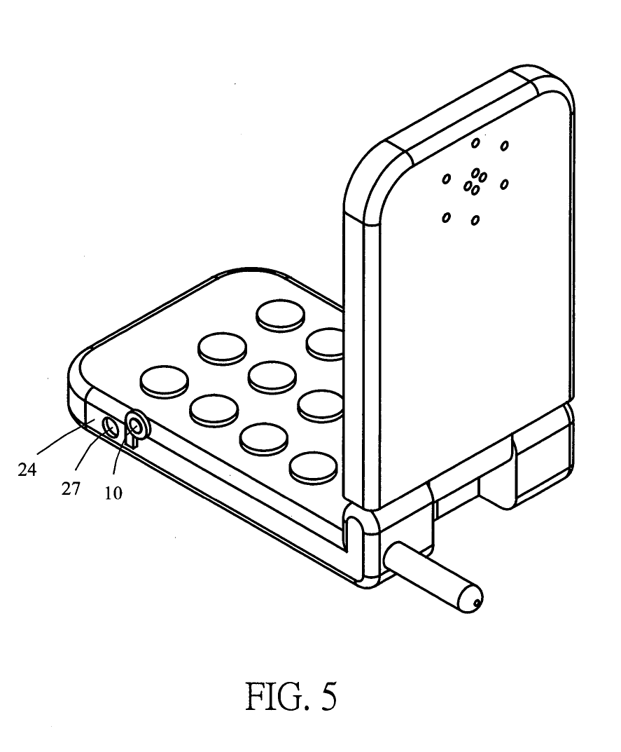

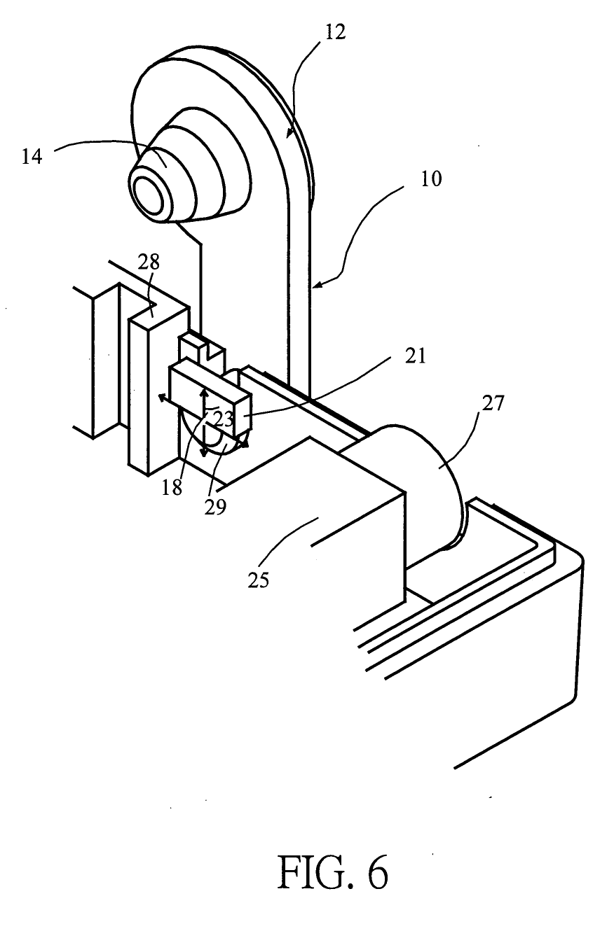

Please refer to FIG. 5 and FIG. 6. FIG. 5 is a top view of the structure of the rotary protection cap 10 of FIG. 1 and FIG. 2 in the state of being pulled out. FIG. 6 is an outside view of the second base 18 and the stopper 28 of the rotary protection cap 10 shown in FIG. 5. When the protrusion 14 is pulled out from the opening 27 of the connector 25, the rotary protection cap 10 is in a state of being rotatable. As showing FIG. 4 and FIG. 6, when the rotary protection cap 10 turns from the second orientation 29 to the first orientation 23, the rotation range of the rotary protection cap 10 is limited due to the contact of the second base 18 and the stopper 28.

When the rotary protection cap 10 structure of the present invention is applied to a mobile phone, the rotary protection cap 10 is being moved instead of being distorted while operating. It is more convenient for users, and it also avoids damages of the external appearance or functions of the protection cap due to deformation over a long period of time.

In conclusion, the structure of rotary protection cap of the present invention allows the rotary protection cap to be rotated structurally coordinately with the housing in a predetermined range, thus making it more convenient for the user's operation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A structure of a rotary protection cap for stuffing into an opening of a connecter to protect the connecter and being rotatable when being pulled out from the opening, the structure comprising:
a rotary protection cap comprising:
a first base comprising a first surface;
a protrusion locating in a first end of the first surface, used for stuffing into or pulling out from the opening;
a rotary axle locating in a second end of the first surface, wherein when pulling the protrusion out of the opening, the rotary protection cap being rotatable around the rotary axle;
a second base, being opposite to the first base, comprising a second surface connecting to the rotary axle;
a housing, which attaches to the connecter in an inner side, comprising:
a fillister for placing the rotary axle, and making the first base to be located at the outer side and the second base in the inner side, to enable the rotary axle be rotatable in the fillister.

2. The structure of claim 1, further defining a first and a second orientation, where the second base extends a pillar along the first orientation.

3. The structure of claim 2, wherein the housing further comprises a stopper locating in the second orientation of the second base; when the rotary protection cap is rotated, the stopper is utilized to stop the rotary protection cap when the second base contacts to the stopper.

4. The structure of claim 1, wherein the rotary axle is a specific multi-dimensional pillar for enabling the rotary protection cap to be rotated and stabilized in a specific angle.

5. The structure of claim 1, wherein the rotary protection cap can be made of plastic.
